(19) United States
(12) Patent Application Publication
(10) Pub. No.: US 2023/0248063 A1
(43) Pub. Date: Aug. 10, 2023

(54) VAPOR GENERATION DEVICE

(71) Applicant: SHENZHEN FIRST UNION TECHNOLOGY CO., LTD., Shenzhen City, Guangdong Province (CN)

(72) Inventors: ZEXIN WU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/011,833

(22) PCT Filed: Jun. 24, 2021
(86) PCT No.: PCT/CN2021/102193

§ 371 Date: Dec. 20, 2022

(30) Foreign Application Priority Data
Jun. 24, 2020 (CN) 202021205658.3

(51) Int. Cl. A24F 40/465; A24F 40/485; H05B 6/10

(52) U.S. Cl. CPC A24F 40/465; A24F 40/485; H05B 6/105

(57) ABSTRACT

A vapor generation device includes an outer housing. The outer housing is internally provided with: an inner tube, in which at least a part of a hollow is configured as a cavity for receiving an inhalable material, where the cavity includes a near end and a far end, and the inhalable material is removably received in the cavity through the near end; and a holder, where an air dielectric layer surrounding the inner tube is formed between the holder and the inner tube, to reduce outward conduction of heat in the cavity, the air dielectric layer includes a closed end close to the near end and an open end close to the far end along a length direction, and the open end is in an airflow communication with the cavity, so that external air is capable of entering the cavity through the open end during inhalation.

### CROSS-REFERENCE TO RELATED APPLICATIONS

This application claims priority to Chinese Patent Application No. 202021205658.3, filed with the China National Intellectual Property Administration on Jun. 24, 2020 and entitled “VAPOR GENERATION DEVICE”, which is incorporated herein by reference in its entirety.

### TECHNICAL FIELD

Embodiments of this application relate to the field of heat not burning cigarette device technologies, and in particular, to a vapor generation device.

### BACKGROUND

Tobacco products (such as cigarettes and cigars) burn tobacco during use to produce tobacco smoke. Attempts are made to replace these tobacco-burning products by manufacturing products that release compounds without being burnt.

An example of the products is a heating device that releases a compound by heating rather than burning a material. For example, the material may be tobacco or other non-tobacco products, where the non-tobacco products may or may not contain nicotine. As another example, there is a heating device that heats a tobacco product through a heater to release a compound to form an aerosol. For example, as a known technology, Patent No. 201280070578.3 provides a design suitable for an airflow path in an inhalation process of a heating device. When the foregoing known device is in use, heat of the heater is radially radiated or transferred outwardly to an outer housing of the device, thereby increasing the temperature of the outer housing.

### SUMMARY

To solve the problem of an increase of housing temperature of a vapor generation device in the related art, embodiments of this application provide a vapor generation device capable of preventing the housing temperature from increasing.

The embodiments of this application provide a vapor generation device, configured to heat an inhalable material to generate an aerosol for inhalation, where the device includes an outer housing, and the outer housing is internally provided with:

an inner tube, configured to extend along a length direction of the housing, where at least a part of a hollow of the inner tube is configured as a cavity for receiving and heating the inhalable material, the cavity includes a near end and a far end opposite to each other along the length direction, and the inhalable material is removably received in the cavity through the near end of the cavity; and

a holder, where an air dielectric layer is formed between the holder and the inner tube, the air dielectric layer is configured to extend along a length direction of the inner tube and surround the inner tube, to reduce outward conduction of heat in the cavity along a radial direction, the air dielectric layer includes a closed end close to the near end and an open end close to the far end along the length direction, and the open end is in an airflow communication with the cavity, so that external air is capable of entering the cavity through the open end during inhalation.

In a preferred implementation, a tube wall of the inner tube is provided with a first air inlet hole arranged close to the far end of the cavity, where the first air inlet hole is in an airflow communication with the open end of the air dielectric layer, so that the external air entering from the open end enters the cavity through the first air inlet hole during inhalation.

In a preferred implementation, the device further includes:

a magnetic field generator, arranged on the holder, and configured to generate a changing magnetic field; and

a susceptor, configured into a pin or sheet shape at least partially extending along an axial direction of the cavity, capable of being penetrated by the changing magnetic field to generate heat, and inserted into the inhalable material for heating when the inhalable material is received in the cavity.

In a preferred implementation, the holder includes a first end close to the near end and a second end close to the far end along the length direction, where

the first end is connected to the inner tube to form the closed end of the air dielectric layer at the first end, and the second end is configured as a free end to form the open end of the air dielectric layer at the second end.

In a preferred implementation, the device further includes:

a mounting base, arranged close to the far end of the cavity, and configured to provide support for the susceptor, where

an extension length of the holder along the length direction of the inner tube basically avoids the mounting base, to prevent heat of the mounting base from being conducted to the holder.

In a preferred implementation, a distance between the first air inlet hole and the first end along a length direction of the holder is less than the length of the holder, so that the external air flows to the first air inlet hole in a direction from the open end to the closed end in the air dielectric layer during inhalation.

In a preferred implementation, the inner tube at least partially surrounds the mounting base.

In a preferred implementation, the vapor generation device is configured in a manner that at least a part of the external air flows from the first air inlet hole to the susceptor along the radial direction of the cavity during the inhalation process.

In a preferred implementation, the outer housing includes a first housing and a second housing, where

at least a part of the second housing is configured as the holder;

the first housing at least partially surrounds the holder and is supported by the holder, and the first housing is movable relative to the second housing along the length direction, to extract the inhalable material received in the cavity.

In a preferred implementation, the second housing is provided with a second air inlet hole being in an airflow communication with the first air inlet hole, and the external air enters the cavity through the second air inlet hole and the first air inlet hole sequentially during inhalation.

According to the foregoing vapor generation device provided in the embodiments of this application, by arranging an air dielectric layer surrounding an inner tube outside the inner tube, and using an open end of the air dielectric layer as an entrance for the air to enter a cavity, heat transfer to the outside of the device housing is reduced through low conductivity of the air dielectric layer and air convection, thereby reducing the temperature of a housing surface.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of a vapor generation device according to an embodiment of this application;

FIG. 2 is a schematic structural diagram of the vapor generation device in FIG. 1 in another state;

FIG. 3 is a schematic structural diagram of the vapor generation device in FIG. 1 in a usage state;

FIG. 4 is a schematic cross-sectional structural diagram of the vapor generation device shown in FIG. 3;

FIG. 5 is a schematic structural diagram of the vapor generation device in FIG. 3 in an extraction state;

FIG. 6 is a schematic structural diagram of an inhalable material held in a cylindrical extractor in FIG. 4;

FIG. 7 is a schematic cross-sectional view of an inhalable material extracted from a heating mechanism in FIG. 4;

FIG. 8 is a schematic structural diagram of the inhalable material received in a heating structure in FIG. 4;

FIG. 9 is a schematic exploded view of each part of the heating mechanism in FIG. 8 before being assembled;

FIG. 10 is a schematic structural diagram of an extraction position of a vapor generation device according to another embodiment of this application; and

FIG. 11 is a schematic structural diagram of the vapor generation device shown in FIG. 10 in an operating position.

### DETAILED DESCRIPTION

For ease of understanding of this application, this application is described in further detail below with reference to the accompanying drawings and specific implementations.

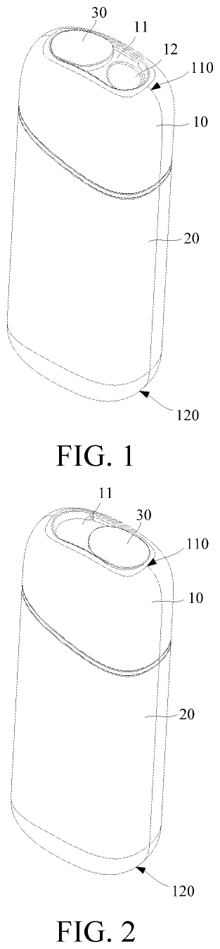

The structure of a vapor generation device provided in an embodiment of this application may be referred to FIG. 1 to FIG. 3. The vapor generation device is configured to receive and heat an inhalable material A, such as a cigarette, to make at least one volatile component thereof volatilized to form an aerosol for inhalation. Base on functional requirements, structural and functional components include:

a housing, overall shape of which is square substantially, that is, a dimension along a length direction being greater than a dimension along a width direction, and the dimension along the width direction being greater than a dimension along a thickness direction. The housing is formed by cooperation of an upper housing 10 and a lower housing 20 sequentially arranged along the length direction. The housing includes a near end 110 and a far end 120 opposite to each other along the length direction; and during use, the near end 110 is used as an end portion brought close to the user for performing the inhalation and operation of the inhalable material A.

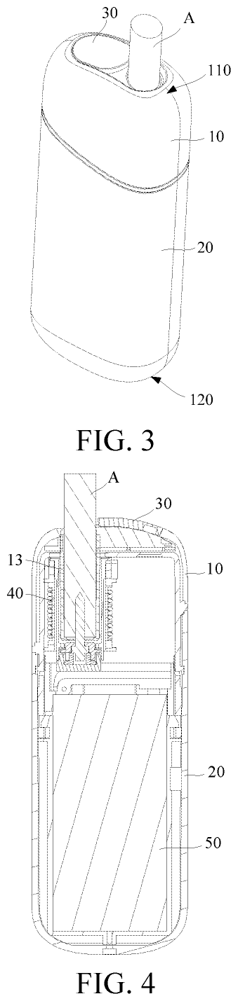

Further according to FIG. 1 to FIG. 3, the near end 110 of the housing is provided with a sliding groove 11 extending along the width direction, and a receiving hole 12 is provided in the sliding groove 11. In addition, a sliding cover 30 that is slidable along a guide direction of the sliding groove 11 is provided in the sliding groove 11, and the receiving hole 12 is opened or closed through the sliding of the sliding cover 30. An open state is shown in FIG. 1 and a closed state is shown in FIG. 2. During use, as shown in FIG. 3, the user can make the inhalable material A at least partially received in the housing along the length direction or remove the inhalable material A from the housing through the receiving hole 12.

Further, to fully implement the function of the vapor generation device, detailed content structure of the vapor generation device is shown in FIG. 4. The space in the housing is divided into two compartments sequentially arranged along the length direction, where the upper compartment is provided with an electromagnetic induction heating mechanism 40 inside, and the lower compartment is provided with a direct current core 50 for supplying power to the heating mechanism 40 inside.

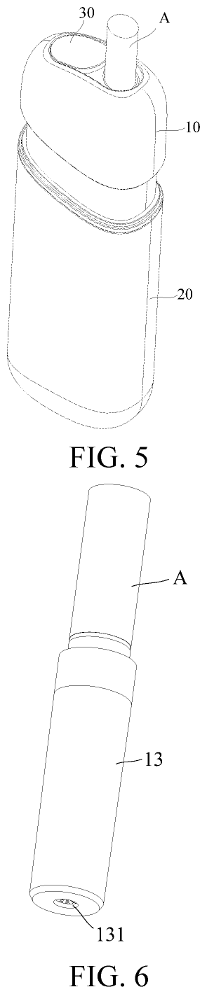

Further, to facilitate the reception and removal operation on the inhalable material A in the heating mechanism 60, referring to FIG. 4 to FIG. 6, an extraction structure for the inhalable material A is arranged on the upper housing 10 of the vapor generation device.

The upper housing 10 is provided with a cylindrical extractor 13 inside, which is integrally fixed with the upper housing 10 by riveting, screwing, or the like. The cylindrical extractor 13 is hollow inside to form a holding space for holding the inhalable material A. As shown in FIG. 6, the inhalable material A is accommodated and held in the cylindrical extractor 13. Further, during use, by moving the upper housing 10 and the lower housing 20 relative to each other, the cylindrical extractor 13 is driven to move along the device, so that the inhalable material A can be carried and received by the heating mechanism 40 or separated from the heating mechanism 40.

Certainly, it can be further seen from the preferred implementation shown in FIG. 6 that a lower end of the cylindrical extractor 13 is provided with a hole 131. During use, a heating component subsequently used for the heating mechanism 40 penetrates into the cylindrical extractor 13 through the hole 131 to heat the inhalable material A.

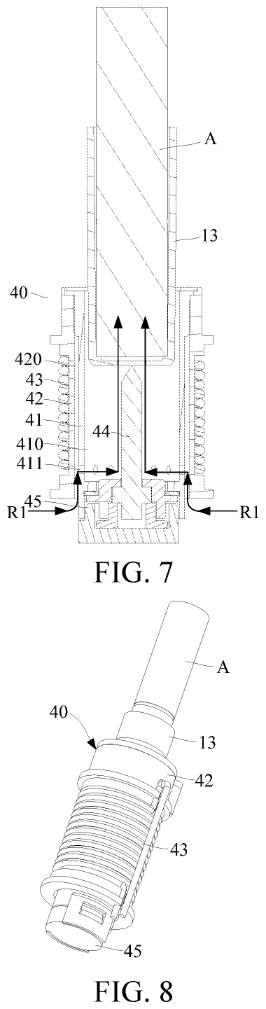

Further referring to FIG. 7 to FIG. 10, the heating mechanism 40 includes:

an inner tube 41, configured to extend along a length direction of the device, where at least a part of an inner space thereof is configured as a cavity 410, and during use, the cylindrical extractor 13 holding the inhalable material A can realize heating and extraction operations on the inhalable material A by being received in or removed from the cavity 410;

a holder 42, configured into a tubular shape extending along the length direction and surrounding the inner tube 41, where a certain distance is kept from the inner tube 41 along a radial direction, to form an air dielectric layer 420, which is configured to insulate the cavity 410 during the heating process by the low thermal conductivity of air;

an induction coil 43, used as a magnetic field generator, configured as a spiral coil arranged outside the holder 42 and extending along an axial direction of the holder 42, and configured to generate an alternating magnetic field penetrating the cavity 410 when the current supplied by the core 50 is inverted into an alternating current and the inverted current is supplied to the induction coil 43;

a susceptor 44, configured into a pin or blade shape extending along an axial direction of the cavity 410 and capable of being penetrated by the changing magnetic field generated by the induction coil 43 to generate heat, and then heat the inhalable material A received in the cavity 140, where generally, the susceptor 44 may be prepared by materials with appropriate magnetic permeability, such as permalloy and stainless iron; and

a mounting base 45, configured to mount and hold the susceptor 44, where during use, the mounting base 45 is fixed inside the vapor generation device, and a lower end of the susceptor 44 is held on the mounting base 45, and a lower end of the inner tube 41 is also supported by the mounting base 45.

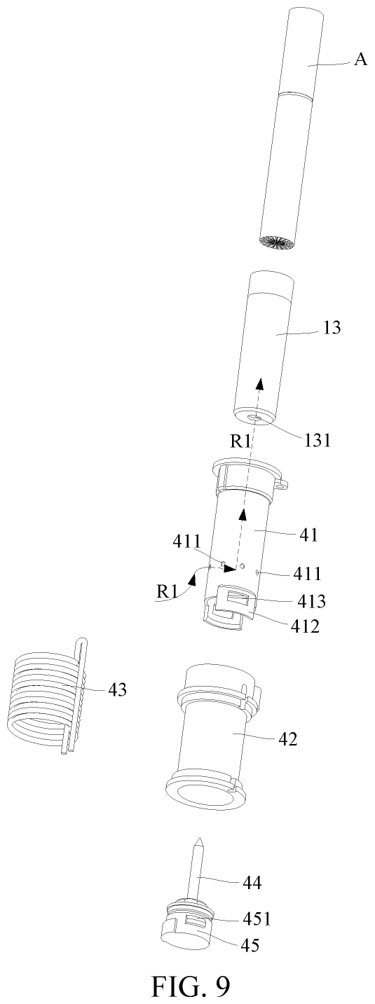

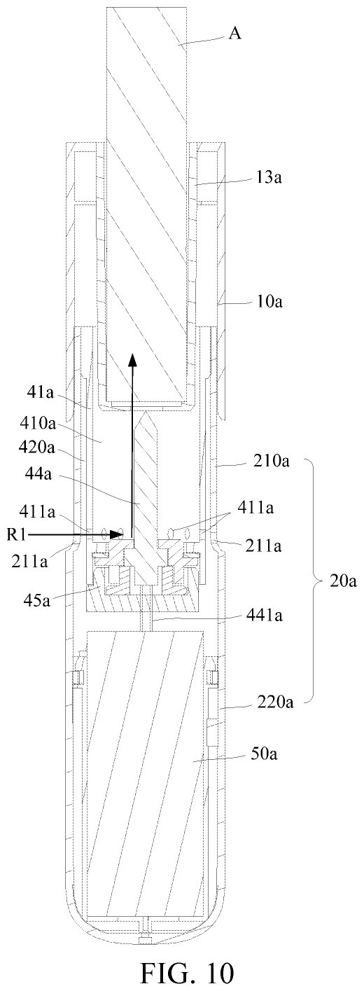

Further, according to the preferred implementation shown in FIG. 7 and FIG. 9, the inner tube 41 is further provided with several air inlet holes 411 close to the lower end. In this way, the airflow path indicated by an arrow R1 in FIG. 7 is formed during use. External air enters the air dielectric layer 420 from a position close to the lower end, then enters the cavity 410 through the air inlet holes 411, and flows into the inhalable material A through the hole 131 of the cylindrical extractor to be inhaled.

Further according to FIG. 7 and FIG. 9, a quantity of the several air inlet holes 411 is relatively large, and the air inlet holes are evenly arranged along a radial direction of the inner tube 41, to keep a suitable inhalation resistance during the inhalation process.

In addition, according to the preferred implementation shown in FIG. 9, the lower end of the inner tube 41 is provided with two extension portions 412 extending toward the mounting base 45. In the implementation, the extension portions 412 surround the mounting base 45, and are buckled and fixed with buckles 451 on the mounting base 45 through catching grooves 413 arranged on the extension portions 412.

An extension length of the holder 42 is relatively shorter than the length of the inner tube 41, and the holder basically avoids the mounting base 45 in length, thereby preventing the heat of the mounting base from being transferred to the holder 42.

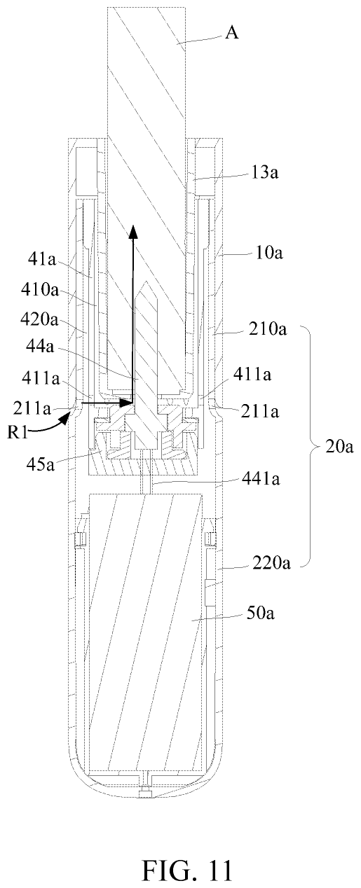

Further, the embodiments of this application further provide another resistive heating vapor generation device, the structure of which is shown in FIG. 10 and FIG. 11. The device includes the following components:

A housing, which is formed by cooperation of a first housing 10a and a second housing 20a that are sequentially arranged along a length direction. Further, the second housing 20a includes a first portion 210a and a second portion 220a that are sequentially arranged along the length direction. And, during use, the first portion 210a is wrapped in the first housing 10a, and is configured as a holder for supporting the first housing 10a. In addition, at least a part of the first housing 10a can move along the length direction under the guidance of an outer surface of the first portion 210a, so that a cylindrical extractor 13a integrally connected to the first housing 10a can realize the extraction of the inhalable material A.

Further, an inner tube 41a is provided in the housing, and an inner space of the inner tube 41a is configured as a cavity 410 for heating and receiving the inhalable material A. During use, the inhalable material A, held by the cylindrical extractor 13a, is removably received in the cavity 410 for heating or removed from the cavity 410.

A resistance heater 44a, which is configured into a pin or blade shape extending along an axial direction of the cavity 410, where the resistance heater 44a is inserted into the inhalable material A for heating when the inhalable material A is received in the cavity 410. In addition, as shown in FIG. 10, the resistance heater 44a is connected to a core 50a arranged in the second portion 220a of the second housing 20a through a conductive pin 441a, and the core 50a provides a direct current to cause the resistance to generate heat. Similarly, based on the concept of mounting and fixation of the resistance heater 44a, a mounting base 45a is provided in the housing for supporting and holding the inner tube 41a and the resistance heater 44a at a lower end, so that the inner tube 41a and the resistance heater 44a are stably held in the housing.

Further, the airflow path in the inhalation process is shown by an arrow R1 in FIG. 10 and FIG. 11. A first air inlet hole 211a is arranged on the first portion 210a of the second housing 20a, and a second air inlet hole 411a is arranged at a position close to the first air inlet hole 211a on the inner tube 41a. In this way, in the inhalation process, external air enters the housing from a gap of a joint portion of the first housing 10a and the second housing 20a, then enters the cavity 410a through the first air inlet hole 211a and the second air inlet hole 411a sequentially, and then enters the inhalable material A through a gap between the hole of the cylindrical extractor 13a and the resistance heater 44a to be inhaled.

Further, in a preferred implementation, the first air inlet hole 211a is arranged at an end portion of the first portion 210a close to the second portion 220a, that is, during use, the first air inlet hole 211a is arranged close to a joint gap between the first housing 10a and the second portion 220a.

During use, according to the airflow path indicated by the arrow R1, the external air basically passes through the housing and the inner tube 41a along the radial direction of the cavity 410a and then enters the cavity 410a, so that the airflow can be transferred as short as possible to reduce the inhalation resistance during use.

In addition, a certain distance is kept between the first portion 210a of the second housing 20a and the inner tube 41a to form an air dielectric layer 420a, which is configured to insulate the cavity 410 during the heating process by the low thermal conductivity of air.

According to the foregoing vapor generation device provided in this application, by arranging an air dielectric layer surrounding an inner tube outside the inner tube, and using an open end of the air dielectric layer as an entrance for the air to enter a cavity, heat transfer to the outside of the device housing is reduced through low conductivity of the air dielectric layer and air convection, thereby reducing the temperature of a housing surface.

It should be noted that, the specification of this application and the accompanying drawings thereof illustrate preferred embodiments of this application, but this application is not limited to the embodiments described in the specification. Further, a person of ordinary skill in the art may make improvements or variations according to the above descriptions, and such improvements and variations shall all fall within the protection scope of the appended claims of this application.

What is claimed is:

1. A vapor generation device, configured to heat an inhalable material to generate an aerosol for inhalation, wherein the device comprises an outer housing, and the outer housing is internally provided with:
an inner tube, configured to extend along a length direction of the housing, wherein at least a part of a hollow is configured as a cavity for receiving the inhalable material, the cavity comprises a near end and a far end opposite to each other along the length direction, and the inhalable material is removably received in the cavity through the near end; and
a holder, wherein an air dielectric layer is formed between the holder and the inner tube, the air dielectric layer is configured to extend along a length direction of the inner tube and surround the inner tube, to reduce outward conduction of heat in the cavity along a radial direction, the air dielectric layer comprises a closed end close to the near end and an open end close to the far end along the length direction, and the open end is in an airflow communication with the cavity, so that external air is capable of entering the cavity through the open end during inhalation.

2. The vapor generation device of claim 1, wherein a tube wall of the inner tube is provided with a first air inlet hole arranged close to the far end of the cavity, wherein the first air inlet hole is in an airflow communication with the open end of the air dielectric layer, so that the external air entering from the open end enters the cavity through the first air inlet hole during inhalation.

3. The vapor generation device of claim 2, further comprising:
a magnetic field generator, arranged on the holder, and configured to generate a changing magnetic field; and
a susceptor, configured into a pin or sheet shape at least partially extending along an axial direction of the cavity, capable of being penetrated by the changing magnetic field to generate heat, and inserted into the inhalable material for heating when the inhalable material is received in the cavity.

4. The vapor generation device of claim 3, wherein the holder comprises a first end close to the near end and a second end close to the far end along the length direction, wherein:
the first end is connected to the inner tube to form the closed end of the air dielectric layer at the first end, and the second end is configured as a free end to form the open end of the air dielectric layer at the second end.

5. The vapor generation device of claim 3, further comprising:
a mounting base, arranged close to the far end of the cavity, and configured to provide support for the susceptor, wherein:
an extension length of the holder along the length direction of the inner tube basically avoids the mounting base, to prevent heat of the mounting base from being conducted to the holder.

6. The vapor generation device of claim 4, wherein a distance between the first air inlet hole and the first end along a length direction of the holder is less than the length of the holder, so that the external air flows to the first air inlet hole in a direction from the open end to the closed end in the air dielectric layer during inhalation.

7. The vapor generation device of claim 5, wherein the inner tube at least partially surrounds the mounting base.

8. The vapor generation device of claim 3, the vapor generation device is configured in a manner that at least a part of the external air flows from the first air inlet hole to the susceptor along the radial direction of the cavity during the inhalation process.

9. The vapor generation device of claim 1, wherein the outer housing comprises a first housing and a second housing, wherein:
at least a part of the second housing forms the holder, the first housing at least partially surrounds the holder and is supported by the holder, and the first housing is movable relative to the second housing along the length direction, to extract the inhalable material received in the cavity.

10. The vapor generation device of claim 9, wherein the second housing is provided with a second air inlet hole being in an airflow communication with the first air inlet hole, and the external air enters the cavity through the second air inlet hole and the first air inlet hole sequentially during inhalation.
